(19) United States
(12) Patent Application Publication
(10) Pub. No.: US 2008/0063355 A1
(43) Pub. Date: Mar. 13, 2008

(54) Data broadcast content reproduction apparatus and data broadcast content reproduction method

(75) Inventor: Shinichiro Nakano, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/896,027

(22) Filed: Aug. 29, 2007

(30) Foreign Application Priority Data
Sep. 8, 2006 (JP) 2006-244730

(51) Int. Cl. H04N 5/91

(52) U.S. Cl. 386/46; 386/E05.001

(57) ABSTRACT

According to one embodiment, a data broadcast content reproduction apparatus includes an acquiring section which is configured to acquire a digital signal corresponding to data broadcast from a received digital broadcast signal, a decoding section which is configured to decode data corresponding to characters and graphics of data broadcast content included in the acquired digital signal, a drawing section which is configured to draw characters and graphics in a form corresponding to a higher resolution than a previously set specified resolution based on the decoded character graphic data, and a creating section which is configured to create a character graphic plane based on the drawn characters and graphics at a resolution at which the characters and graphics have been drawn.

### CROSS-REFERENCE TO RELATED APPLICATIONS

This application is based upon and claims the benefit of priority from Japanese Patent Application No. 2006-244730, filed Sep. 8, 2006, the entire contents of which are incorporated herein by reference.

### BACKGROUND

1. Field

One embodiment of the invention relates to a data broadcast content reproduction apparatus and data broadcast content reproduction method for displaying characters and graphics representing received data broadcast content on a display unit.

2. Description of the Related Art

As is well known, in recent years, digitization of TV broadcasting has been promoted. For example, in Japan, not only satellite digital broadcasting such as broadcasting satellite (BS) digital broadcasting and 110-degree communication satellite (CS) digital broadcasting, but also terrestrial digital broadcasting have been started.

In such circumstances, development of a high-definition display device for a TV broadcast receiving apparatuses that receives such digital broadcast has been promoted. For example, a full HD (high-definition) display has a display resolution of 1920 (=number of pixels in the horizontal direction)×1080 (=number of pixels in the vertical direction) and thus can display high-definition and high-quality images.

On the other hand, in data broadcast that has already been put to practical use as part of the satellite digital broadcasting, the resolution of the character graphic plane for displaying characters and graphics representing the content of the data broadcast is specified at 960×540 (=number of pixels in the horizontal direction×number of pixels in the vertical direction). That is, within the character graphic plane, characters and graphics are drawn within the specified resolution range.

Thus, currently, when the character graphic plane whose resolution has been specified as described above is displayed in the abovementioned full-HD display, the resolution of the character graphic plane is doubled in the horizontal and vertical directions by scaling so as to fit to the resolution of the full-HD display.

This means, however, that the sizes of the characters and graphics drawn at a lower resolution are simply doubled in the horizontal and vertical directions. Accordingly, display quality level of the characters and graphics is deteriorated, which may cause the profiles of the characters and graphics to be displayed in a stepwise or zigzag pattern.

At present, in order to cope with this, filtering is applied to the character graphic plane that has been subjected to scaling to thereby reduce the stepwise pattern. However, deterioration in the display quality level is obvious as compared with the case of moving images. Further, strong filtering may lower the sharpness of the characters and graphics.

Jpn. Pat. Appln. Publication No. 2002-287734 discloses a display method of character data in a character display apparatus which calculates the ratio of the resolution of a monitor part relative to the resolution of character data and converts the character data resolution in accordance with the monitor part resolution so as to display characters even when the resolution of the character data to be displayed is different from the resolution of the monitor part.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a view showing an embodiment of the present invention, which schematically shows the outer appearance of a digital TV broadcast receiving apparatus and an example of a network system constituted with the digital TV broadcast receiving apparatus as a main component;

FIG. 2 is a block diagram for explaining a main signal processing system in the digital TV broadcast receiving apparatus according to the present embodiment;

FIG. 3 is a block diagram for explaining a main reproduction system in the digital TV broadcast receiving apparatus according to the present embodiment, which applies reproduction processing for video components; and

FIG. 4 is a block diagram for explaining an example of a character graphic reproduction processor in the digital TV broadcast receiving apparatus according to the present embodiment.

### DETAILED DESCRIPTION

Various embodiments according to the invention will be described hereinafter with reference to the accompanying drawings. In general, according to one embodiment of the invention, a data broadcast content reproduction apparatus includes: an acquiring section which is configured to acquire a digital signal corresponding to data broadcast from a received digital broadcast signal; a decoding section which is configured to decode data corresponding to characters and graphics of data broadcast content included in the acquired digital signal; a drawing section which is configured to draw characters and graphics in a form corresponding to a higher resolution than a previously set specified resolution based on the decoded character graphic data; and a creating section which is configured to create a character graphic plane based on the drawn characters and graphics at a resolution at which the characters and graphics have been drawn.

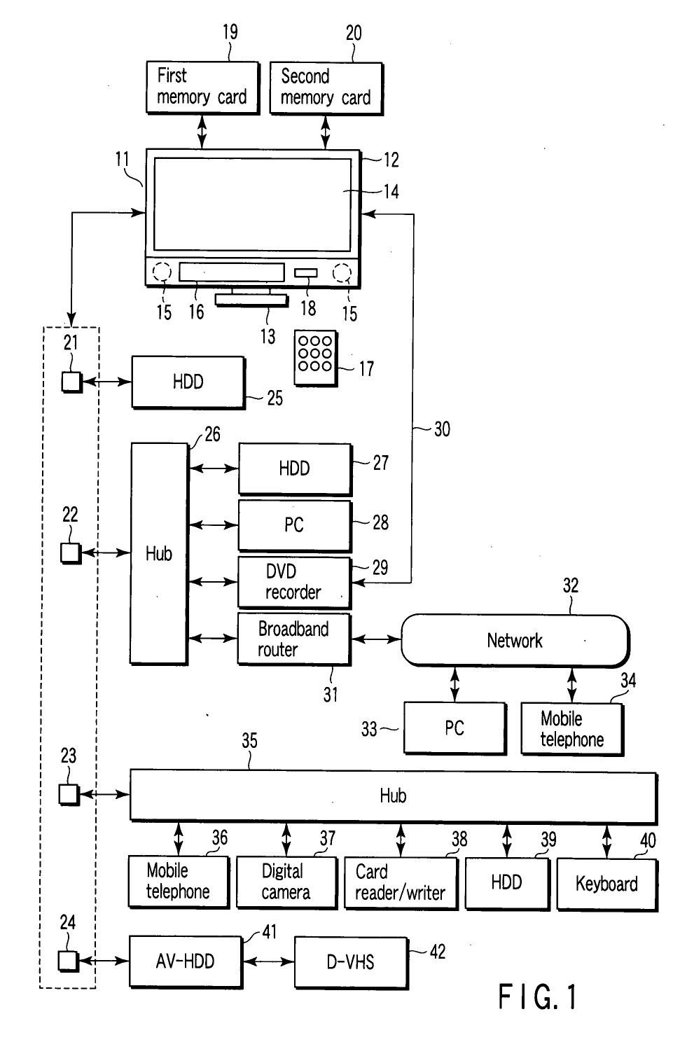

FIG. 1 schematically shows the outer appearance of a digital TV broadcast receiving apparatus 11 to be described in the present embodiment and an example of a network system constituted with the digital TV broadcast receiving apparatus 11 as a main component.

The digital TV broadcast receiving apparatus 11 is mainly composed of a thin type cabinet 12, and a support base 13 for supporting the cabinet 12 upright. The cabinet 12 includes an image display 14 such as a flat-panel display provided with a liquid crystal display panel and the like, a speaker 15, an operation unit 16, and a light receiving unit 18 for receiving operational information sent from a remote controller 17.

The digital television broadcast receiving apparatus 11 is configured to have a first memory card 19 detachably loaded thereon, such as an SD (secure digital) memory card, an MMC (multimedia card), or a memory stick. Information including TV programs and photos are recorded in and reproduced from the first memory card 19.

The digital television broadcast receiving apparatus 11 is also configured to have detachably loaded thereon a second memory card (IC (integrated circuit) card) 20 carrying, for example, contract information. Information are recorded in and reproduced from the second memory card 20.

The digital television broadcast receiving apparatus 11 includes a first LAN (local area network) terminal 21, a second LAN terminal 22, a USB (universal serial bus) terminal 23, and an IEEE (institute of electrical and electronics engineers) 1394 terminal 24.

The first LAN terminal 21 is used as a LAN specific HDD dedicated port and recording and reproducing information in and from a LAN specific HDD (hard disk drive) 25 which is a NAS (network attached storage) connected to the first LAN terminal 21 over the Ethernet™.

As the first LAN terminal 21 serves as the LAN specific HDD dedicated port, it is possible to stably record information of the programs at high-definition TV quality in the HDD 25 regardless of the conditions of the network environment and usage of the network.

Also, the second LAN terminal 22 is used as a common LAN specific port over the Ethernet™. For example, the second LAN terminal 22 is connected via a hub 26 to a LAN specific HDD 27, a PC (personal computer) 28, and an HDD built-in DVD (digital versatile disk) recorder 29 for exchanging information with each other.

With respect to the DVD recorder 29, digital information communicated via the second LAN terminal 22 is only information of a control system, and therefore, an analog signal transmission path 30 is needed between the DVD recorder 29 and the digital television broadcast receiving apparatus 11 for transmission of analog video and audio information.

The second LAN terminal 22 is connected via a broadband router 31 connected to the hub 26 to a network 32 such as the Internet, for exchanging information with a PC 33 or a mobile telephone 34 via the network 32.

The USB terminal 23 is used as a common USB specific port. For example, the USB terminal 23 is connected via a hub 35 to a mobile telephone 36, a digital camera 37, a card reader/writer 38 for the memory card, an HDD 39, a keyboard 40, and other USB devices for exchanging information with each other.

The IEEE 1394 terminal 24 is used for serially connecting to, for example, an AV (audio-video)-HDD 41, a D-VHS (digital video home system) 42 for exchanging information with each other.

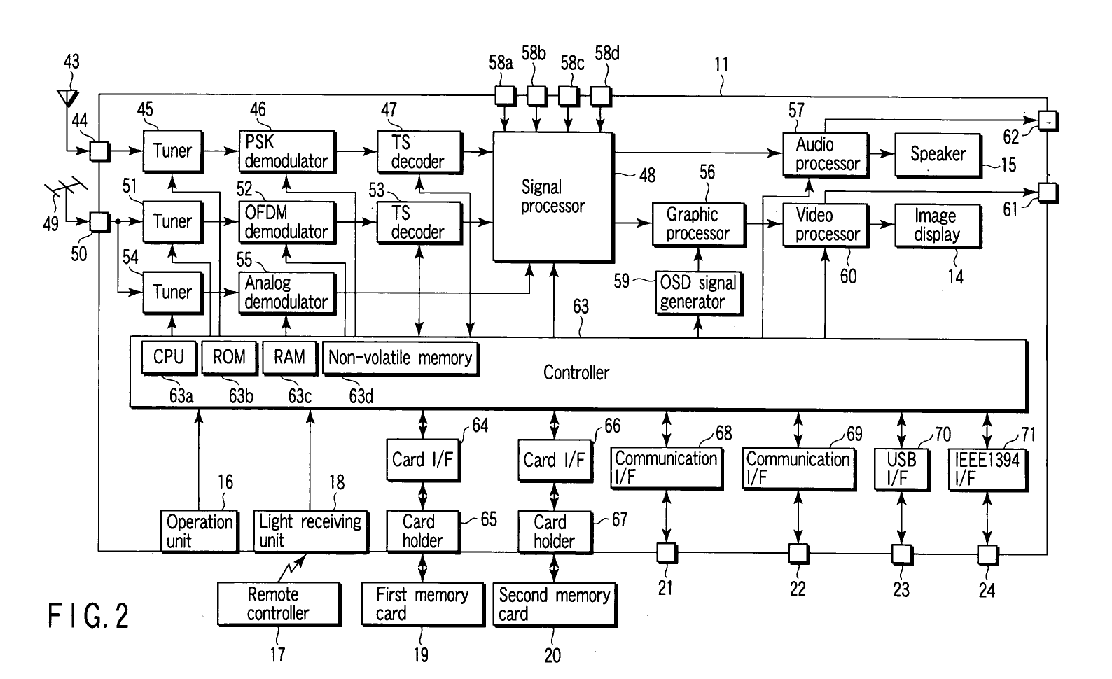

FIG. 2 shows a main signal processing system in the digital television broadcast receiving apparatus 11. Specifically, a digital satellite broadcast signal received at a BS/CS digital broadcast signal receiving antenna 43 is supplied via an input terminal 44 to a digital satellite broadcast tuner 45, whereby a broadcast signal of a desired channel is channel-selected.

The broadcast signal which has been channel-selected by the tuner 45 is then supplied to a PSK (phase shift keying) demodulator 46 where a TS (transport stream) is demodulated from the received broadcast signal. The TS is then supplied to a TS decoder 47, decoded and separated into a digital video signal and a digital audio signal, and then outputted to a signal processor 48.

A digital terrestrial television broadcast signal received at an antenna 49 for terrestrial broadcast signal reception is supplied via an input terminal 50 to a digital terrestrial broadcast tuner 51, whereby a broadcast signal of a desired channel is selected.

The broadcast signal which has been channel-selected by the tuner 51 is then supplied to an OFDM (orthogonal frequency division multiplexing) demodulator 52 where a TS is demodulated. The TS is then supplied to a TS decoder 53, decoded and separated into a digital video signal and a digital audio signal, and then outputted to the signal processor 48.

An analog terrestrial television broadcast signal received at the antenna 49 for terrestrial broadcast signal reception is supplied via the input terminal 50 to an analog terrestrial broadcast tuner 54, whereby a broadcast signal of a desired channel is selected. The broadcast signal which has been channel-selected by the tuner 54 is supplied to an analog demodulator 55, demodulated to an analog video signal and an analog audio signal, and then outputted to the signal processor 48.

The signal processor 48 is provided for selectively applying digital signal processing to the digital video signal and digital audio signal supplied from the TS decoders 47 and 53, respectively, and outputting the signals to a graphic processor 56 and an audio processor 57.

The signal processor 48 is connected to a plurality of input terminals (four in the embodiment) 58a, 58b, 58c, and 58d. The input terminals 58a, 58b, 58c, and 58d can receive analog video and audio signals from the outside of the digital television broadcast receiving apparatus 11.

The signal processor 48 selectively digitizes the analog video and audio signals respectively supplied from the analog demodulator 55 or the input terminals 58a to 58d, applies predetermined digital signal processing to the digitized video and audio signals and then outputs the signals to the graphic processor 56 and the audio processor 57.

The graphic processor 56 has a function of superimposing an OSD (on careen display) signal generated from an OSD signal generator 59 over the digital video signal supplied from the signal processor 48. The graphic processor 56 is also configured to selectively output the video output signal of the signal processor 48 and the OSD output signal of the OSD signal generator 59 and to output both the output signals so as to simultaneously display two separate images on the screen.

The digital video signal outputted from the graphic processor 56 is supplied to a video processor 60. The video processor 60 converts the inputted digital video signal into an analog video signal of the format which can be displayed by the image display 14. Then, the video processor 60 outputs the analog video signal to the image display 14 for displaying its image and derives it via an output terminal 61 to the outside.

The audio processor 57 converts the inputted digital audio signal into an analog audio signal of the format which can be reproduced by the speaker 15. Then, the audio processor 57 outputs the analog audio signal to the speaker 15 for reproducing its sound and derives it via an output terminal 62 to the outside.

All the operations of the digital television broadcast receiving apparatus 11 including the above-described various receiving operations are entirely controlled by a controller 63. The controller 63 is equipped with a built-in CPU (central processing unit) 63a for controlling each unit such that its operation contents are appropriately reflected in response to operational information received from the operation unit 16 or operational information sent from the remote controller 17 via the light-receiving unit 18.

In this case, the controller 63 mainly uses a ROM (read only memory) 63b in which control programs to be executed by the CPU 63a are stored, a RAM (random access memory) 63c for providing the working area for the CPU 63a, and a non-volatile memory 63d in which various setting information and control information are stored.

The controller 63 is connected via a card I/F (interface) 64 to a card holder 65 to which the first memory card 19 can be detachably loaded. This allows the controller 63 to exchange information via the card I/F 64 with the first memory card 19 loaded to the card holder 65.

The controller 63 is also connected via a card I/F 66 to a card holder 67 to which the second memory card 20 can be detachably loaded. This allows the controller 63 to exchange information via the card I/F 66 with the second memory card 20 loaded to the card holder 67.

The controller 63 is further connected via a communication I/F 68 to the first LAN terminal 21. This allows the controller 63 to exchange information via the communication I/F 68 with the LAN specific HDD 25 connected to the first LAN terminal 21. In this case, the controller 63 has a DHCP (dynamic host configuration protocol) server function for controlling by assigning an Internet protocol (IP) address to the LAN specific HDD 25 connected to the first LAN terminal 21.

The controller 63 is further connected via another communication I/F 69 to the second LAN terminal 22. This allows the controller 63 to exchange information via the communication I/F 69 with each device (See FIG. 1) connected to the second LAN terminal 22.

The controller 63 is further connected via a USB I/F 70 to the USB terminal 23. This allows the controller 63 to exchange information via the USB I/F 70 with each device (See FIG. 1) connected to the USB terminal 23.

The controller 63 is further connected via an IEEE 1394 I/F 71 to the IEEE 1394 terminal 24. This allows the controller 63 to exchange information via the IEEE 1394 I/F 71 with each device (See FIG. 1) connected to the IEEE 1394 terminal 24.

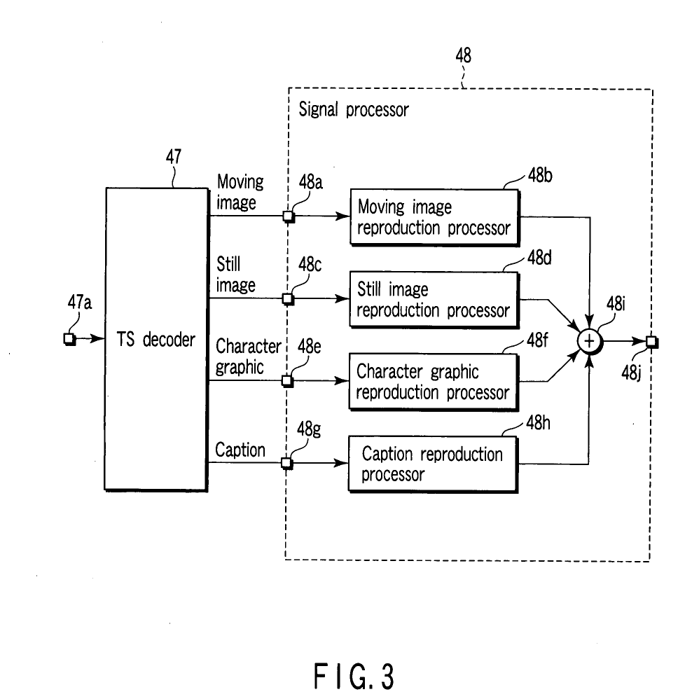

Now, reproduction processing for video components including data broadcast content, caption content, and the like performed in the TS decoder 47 and signal processor 48 will be described. Specifically, as shown in FIG. 3, the TS demodulated in the PSK demodulator 46 is supplied via the input terminal 47a to the TS decoder 47.

The TS decoder 47 separates the input TS into digital signals corresponding to a moving image, a still image, characters and graphics of data broadcast content, and caption content, respectively, and outputs them to the signal processor 48.

The digital signal corresponding to a moving image is supplied via the input terminal 48a to a moving image reproduction processor 48b constituting the signal processor 48. The moving image reproduction processor 48b applies decoding processing and presentation processing to the input digital signal corresponding to a moving image to thereby generate a moving image plane which can be displayed by the image display 14.

The digital signal corresponding to a still image is supplied via the input terminal 48c to a still image reproduction processor 48d constituting the signal processor 48. The still image reproduction processor 48d applies decoding processing and presentation processing to the input digital signal corresponding to a still image to thereby generate a still image plane which can be displayed by the image display 14.

The digital signal corresponding to characters and graphics is supplied via the input terminal 48e to a character graphic reproduction processor 48f constituting the signal processor 48. The character graphic reproduction processor 48f applies decoding processing and presentation processing to the input digital signal corresponding to characters and graphics to thereby generate a character graphic plane which can be displayed by the image display 14.

The digital signal corresponding to caption content is supplied via the input terminal 48g to a caption reproduction processor 48h constituting the signal processor 48. The caption reproduction processor 48h applies decoding processing and presentation processing to the input digital signal corresponding to caption content to thereby generate a caption plane which can be displayed by the image display 14.

The moving image plane generated in the moving image reproduction processor 48b, still image plane generated in the still image reproduction processor 48d, character graphic plane generated in the character graphic reproduction processor 48f, and caption plane generated in the caption reproduction processor 48h are supplied to a synthesizer 48i where the above planes are superimposed over each other. Then, the superimposed plane is output via an output terminal 48j to the graphic processor 56 so as to be displayed by the image display 14.

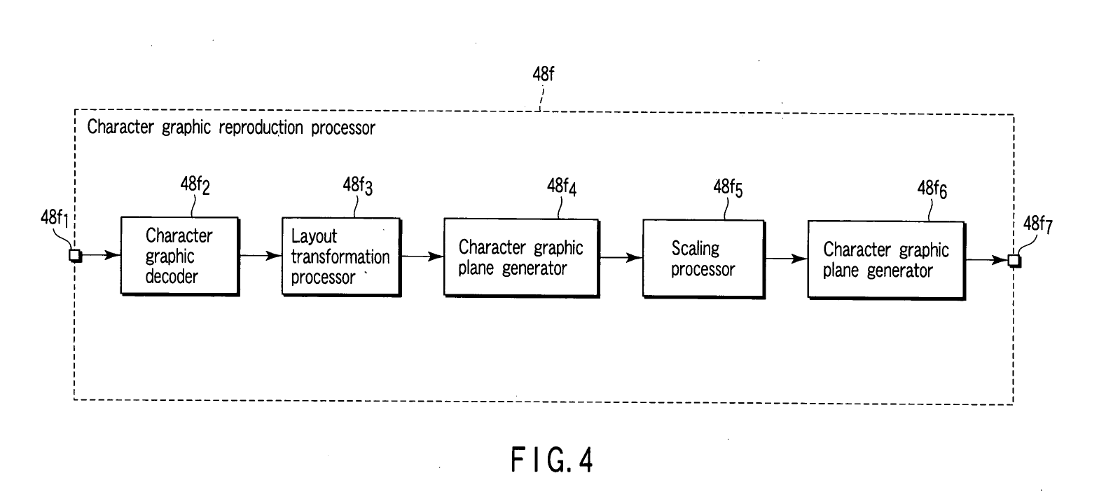

FIG. 4 shows an example of a configuration of the character graphic reproduction processor 48f. Specifically, the digital signal corresponding to characters and graphics supplied to the input terminal 48e is supplied via an input terminal 48f1 to a character graphic decoder 48f2 where the digital signal is subjected to decoding processing. The resultant signal is then supplied to a layout transformation processor 48f3.

In the layout transformation processor 48f3, a coordinate values (pixel positions) on a display screen are set for the character graphic data decoded in the character graphic decoder 48f2 such that the character graphic data can be drawn in a form corresponding to the display resolution (number of pixels) of the image display 14, i.e., the character graphic data can be drawn in the highest quality form within the display resolution without any layout change.

That is, assuming that the display resolution of the image display 14 is 1920×1080 (=number of pixels in the horizontal direction×number of pixels in the vertical direction) which is Full HD class resolutions, pixels for displaying characters and graphics are set such that the characters and graphics can be drawn in the highest quality form within the number of pixels (1920×1080) with their layouts maintained.

The characters and graphics thus drawn are displayed in a dramatically higher quality form as compared with characters and graphics obtained by simply doubling the sizes of characters and graphics originally drawn within a specified resolution (960×540=number of pixels in the horizontal direction×number of pixels in the vertical direction) in the horizontal and vertical directions respectively (in this case, for example, the distance corresponding to three horizontally arranged pixels is simply doubled to a distance corresponding to six horizontally arranged pixels and accordingly the display quality level of the characters and graphics is deteriorated, which may cause the profiles of the characters and graphics to be displayed in a stepwise or zigzag pattern).

Then, the character graphic data that has been subjected to the drawing processing in the layout transformation processor 48f3 is supplied to a character graphic plane generator 48f4, where a character graphic plane having a resolution corresponding to the display resolution of the image display 14 (i.e., 1920×1080=number of pixels in the horizontal direction×number of pixels in the vertical direction) is generated for the supplied character graphic data.

Thereafter, the character graphic plane generated in the character graphic plane generator 48f4 undergoes fine adjustment in the horizontal and vertical directions by a scaling processor 48f5. Subsequently, a character graphic plane generator 48f6 generates a final character graphic plane, which is output via an output terminal 48f7 to the synthesizer 48i so as to be synthesized with other planes.

According to the abovementioned embodiment, a character graphic plane is generated such that characters and graphics are drawn in a higher quality form corresponding to the display resolution (1920×1080=number of pixels in the horizontal direction×number of pixels in the vertical direction) of the image display 14 than at the quality level in the specified resolution, thereby reducing the scaling ratio in the scaling processor 48f5 of the subsequent stage.

This allows characters and graphics to be displayed in a dramatically higher quality form as compared with a case where simple scaling processing in which the sizes of characters and graphics originally drawn within a specified resolution (960×540=number of pixels in the horizontal direction×number of pixels in the vertical direction) are merely doubled in the horizontal and vertical directions respectively.

The image display 14 may have a display resolution conforming to a WXGA (wide extended graphics array) specification, i.e., have a display resolution of 1366×768 (=number of pixels in the horizontal direction×number of pixels in the vertical direction) which is lower than the full-HD specification.

In this case, the scaling processor 48f5 of the subsequent stage performs scaling processing such that a character graphic plane obtained by drawing characters and graphics in a form corresponding to the full HD resolution (1920×1080=number of pixels in the horizontal direction×number of pixels in the vertical direction) output from the character graphic plane generator 48f4 fits to the display resolution of the WXGA specification.

In this scaling processing, the character graphic plane generated in the character graphic plane generator 48f4 is reduced to a character graphic plane having a smaller number of display pixels, and the reduction ratio does not reach even 1/2 (50%). This allows high quality characters and graphics to be displayed by the character graphic plane after scaling processing.

As a resolution specified for a character graphic plane, there exists one having a resolution of 720×480 (=number of pixels in the horizontal direction×number of pixels in the vertical direction) in addition to the abovementioned resolution of 960×540 (=number of pixels in the horizontal direction×number of pixels in the vertical direction). Also in the case where the former specification is adopted, the layout transformation processor 48f3 draws characters and graphics in a form corresponding to the display resolution of 1440×960 (=number of pixels in the horizontal direction×number of pixels in the vertical direction) which is obtained by doubling the specified resolution (720×480) in the horizontal and vertical directions respectively. That is, the character graphic plane generator 48f4 generates a character graphic plane having a display resolution of 1440×960 (=number of pixels in the horizontal direction×number of pixels in the vertical direction).

The numerical value “double” in the layout transformation processing means a practical optimal value determined on the basis of the full HD resolution (1920×1080), which is now becoming mainstream, with respect to the resolutions (960×540, 720×480) specified for a character graphic plane.

In the case where the image display 14 has a full HD display resolution (1920×1080=number of pixels in the horizontal direction×number of pixels in the vertical direction), the scaling processor 48f5 magnifies the resolution (1440×960=number of pixels in the horizontal direction×number of pixels in the vertical direction) of a character graphic plane in the horizontal and vertical directions so as to fit the character graphic plane to the full HD display resolution. In this case, the enlargement ratio does not reach even “double” (200%). This allows high quality characters and graphics to be displayed by the character graphic plane after scaling processing.

Further, in the case where the image display 14 has a display resolution conforming to a WXGA specification (1366×768=number of pixels in the horizontal direction×number of pixels in the vertical direction), the scaling processor 48f5 reduces the resolution (1440×960=number of pixels in the horizontal direction×number of pixels in the vertical direction) of a character graphic plane in the horizontal and vertical directions so as to fit the character graphic plane to the WXGA display resolution. In this case, the reduction ratio does not reach even 1/2 (50%). This allows high quality characters and graphics to be displayed by the character graphic plane after scaling processing.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A data broadcast content reproduction apparatus comprising:
an acquiring section which is configured to acquire a digital signal corresponding to data broadcast from a received digital broadcast signal;
a decoding section which is configured to decode data corresponding to characters and graphics of data broadcast content included in the digital signal acquired by the acquiring section;
a drawing section which is configured to draw characters and graphics in a form corresponding to a higher resolution than a previously set specified resolution based on character graphic data obtained by the decoding section; and
a creating section which is configured to create a character graphic plane based on the characters and graphics drawn by the drawing section at a resolution at which the characters and graphics have been drawn.

2. The data broadcast content reproduction apparatus according to claim 1, wherein
the drawing section is configured to draw characters and graphics in a form corresponding to a resolution obtained by doubling the previously set specified resolution in the horizontal and vertical directions, respectively.

3. The data broadcast content reproduction apparatus according to claim 1, wherein
the drawing section is configured to draw characters and graphics in a form corresponding to either a resolution of 1920×1080 (=number of pixels in the horizontal direction×number of pixels in the vertical direction) or resolution of 1440×960 (=number of pixels in the horizontal direction×number of pixels in the vertical direction).

4. The data broadcast content reproduction apparatus according to claim 1, wherein
the previously set specified resolution is a resolution of 960×540 (=number of pixels in the horizontal direction×number of pixels in the vertical direction) or resolution of 720×480 (=number of pixels in the horizontal direction×number of pixels in the vertical direction).

5. The data broadcast content reproduction apparatus according to claim 1, further comprising a scaling section which is configured to perform scaling processing for the character graphic plane that has been created by the creating section so as to fit the character graphic plane to a higher resolution than the previously set specified resolution.

6. A digital broadcast receiving apparatus comprising:
a receiving section which is configured to receive a digital broadcast signal;
an acquiring section which is configured to acquire a digital signal corresponding to data broadcast from the digital broadcast signal received by the receiving section;
a decoding section which is configured to decode data corresponding to characters and graphics of data broadcast content included in the digital signal acquired by the acquiring section;
a drawing section which is configured to draw characters and graphics in a form corresponding to a higher resolution than a previously set specified resolution based on character graphic data obtained by the decoding section;
a creating section which is configured to create a character graphic plane based on the characters and graphics drawn by the drawing section at a resolution at which the characters and graphics have been drawn; and
a displaying section which is configured to display the character graphic plane that has been created by the creating section.

7. The digital broadcast receiving apparatus according to claim 6, further comprising a generation section which is configured to generate an image plane including either a moving image or still image from the digital broadcast signal received by the receiving section; and
a synthesizing section which is configured to synthesize the image plane generated by the generation section and the character graphic plane that has been created by the creating section and supplies the synthesized plane to the displaying section.

8. A data broadcast content reproduction method comprising:
acquiring a digital signal corresponding to data broadcast from a received digital broadcast signal;
decoding data corresponding to characters and graphics of data broadcast content included in the acquired digital signal;
drawing characters and graphics in a form corresponding to a higher resolution than a previously set specified resolution based on the decoded character graphic data; and
creating a character graphic plane based on the drawn characters and graphics at a resolution at which the characters and graphics have been drawn.
